(19) United States
(12) Patent Application Publication
(10) Pub. No.: US 2004/0104156 A1
(43) Pub. Date: Jun. 3, 2004

(54) Chromatographic separation processes and apparatus

(76) Inventors: Henry S. Kolesinski, Naples, FL (US); Jonathan N. Kremsky, Arlington, MA (US)

Correspondence Address: Gaetano D. Maccarone, Esq., 63 Chelsea Street, Charlestown, MA, 02129, US

(21) Appl. No.: 10/721,131

(22) Filed: Nov. 25, 2003

Related U.S. Application Data
(60) Provisional application No. 60/429,228, filed on Nov. 26, 2002.

(51) Int. Cl. C02F 1/28; B01D 15/08

(52) U.S. Cl. 210/198.2; 210/656

(57) ABSTRACT

There are described processes and apparatus for the separation of components from a mixture of components in a fluid such as biological materials in a fermentation broth or other biomass product. The fluid mixture is passed through a plurality of individual separation modules which are in sequential fluid communication, at least one of which can be isolated from the other(s). The individual separation modules include chemically active capture materials which are capable of capturing desired components from the mixture. The chemically active capture material of each individual separation module may have the same chemical activity or the chemically active capture material of at least one separation module may have a different chemical activity than that of the capture material of the other separation module(s).

### REFERENCE TO RELATED APPLICATION

This application claims the benefit of prior provisional application serial No. 60/429,228, filed Nov. 26, 2002.

Reference is made to co-pending, commonly assigned application Ser. No. aa/AAA,AAA,(Attorney docket No. HK002AFP), filed on even date herewith.

### FIELD OF THE INVENTION

This application relates to processes and apparatus for separating substances chromatographically and, more particularly, to such processes and apparatus in which fluids containing mixtures of components, such as, for example, fermentation products and other biomass products, are passed through a plurality of individual separation modules which are in fluid communication with each other.

### BACKGROUND OF THE INVENTION

The continuing surge in the development of biotechnology products and processes has brought with it the need for efficient and cost effective separation and purification processes and apparatus. The preparation of new drugs via recombinant DNA/fermentation continues to expand with the introduction of new candidates on a regular basis. The preparation of new drugs by fermentation processes can be divided into two general categories which are typically generally referred to as “upstream” and “downstream” processes. The upstream processes address the biochemical design of the system to produce the desired biopharmaceutical product and the downstream processes focus on harvesting and purifying the final product.

Downstream processing involves the following functions: a) cell disruption, if necessary, to free the contents of the fermentation cells; b) centrifugation to provide clarification of the contents by separating the cell debris from the mother liquor containing the desired product and other biological entities; c) ultrafiltration to concentrate the mother liquor for subsequent steps; and d) final product purification, typically by liquid chromatographic techniques using multi-method separation methods, e.g., ion exchange, hydrophobic interaction, reverse phase, chiral, etc. These batch processes are time consuming and expensive to practice, typically requiring large amounts of elution solvents. It is estimated that about 70-80% of the cost of preparing drugs is associated with the separation and purification of such products.

As the state of the art in the separation and collection of desired products from fluids containing mixtures of components advances and efforts are made to eliminate or at least reduce the disadvantageous characteristics of the present techniques, there is a continuing need for improved separation processes and apparatus.

### SUMMARY OF THE INVENTION

It is therefore an object of this invention to provide novel processes and apparatus for the separation of mixtures of components in fluids.

It is another object to provide such processes and apparatus wherein separation of mixtures of components in fluids can be carried out on a continuous basis.

It is still another object to provide such processes and apparatus for the separation of mixtures of biological components in fluids.

It is a further object to provide such processes and apparatus for the removal and partial purification of small- and macromolecules which are produced by the fermentation of microbial cells.

Yet another object is to provide such processes and apparatus which are useful in the process scale purification of products produced by chemical synthesis.

These and other objects and advantages are attained in accordance with the present invention by providing apparatus, and continuous processes, for separating mixtures of components in fluids. In one aspect of the invention there is provided a separation apparatus, or column, which includes a plurality of individual separation modules which are in sequential fluid communication with each other, at least one of which can be isolated from the other(s) when desired. Each separation module contains chemically active capture materials, such as collection plates or particulate materials, which are adapted to capture specific desired components from the mixture. The chemically active capture materials can be provided by treating the surface of the capture material with suitable chemicals such as functional polymer coatings or chemical derivatization of the support materials. The capture materials allow the flow through the module of unwanted components such as cell debris and simultaneous capture of desired product by specific chemical interaction with the treated capture material. Thus, lysed fermentation broth can be injected directly onto the separation column made up of the plurality of separation modules and the desired product captured and removed.

The separation column of the invention can also include a sample loading module, or unit, which is in fluid communication with a separation module of the column. In this embodiment the sample loading module serves as a reservoir for the initial fluid mixture and does not contain any capture material. Fluid flow into the separation module can be initiated by various means including applying a vacuum to the column.

In one embodiment of the invention, the capture material in each module has the same chemical activity. In another embodiment, the capture material in one or more of the modules has a first chemical activity and the capture material in one or more of the modules has a second chemical activity, the first and second chemical activities being different.

Where collection plates are used as the capture material according to the invention, they typically have flow channels of about 50μ or greater, preferably 75μ or greater and particularly preferably 100μ or greater. When particulate materials are employed as the capture materials the particle size is typically about 100μ.

Employing standard chromatographic techniques, in preferred embodiments, the apparatus and processes of the invention permit the use of multiple modules where separation of components occurs in each module and product capture and partial purification of the captured product are accomplished in each module. A separation method known as displacement chromatography can be particularly effective in separating products into different modules. Identifying the module which contains the desired product represents a partial purification and concentration step.

In a preferred embodiment, each of the individual modules in the column can be isolated from the other(s) and the contents from any specific module harvested without the need to collect fractions from the total injected volume. The ability to isolate specific products from specific separation modules minimizes the need to use large amounts of elution solvents. This feature of the processes and apparatus of the invention is extremely useful in the process scale separation and purification of small molecules using preparative size, chemically active porous particles, both under normal phase and reverse phase conditions. In particular, normal phase chromatographic separations require large amounts of hazardous organic solvents. By isolating the particular desired product band in a specific separation module according to the invention, the amount of solvent required to elute the product from the active support material is minimal compared to standard chromatographic separation conditions. Thus, the separation processes of the invention are cost efficient and environmentally desirable.

The use of a plurality of individual separation modules permits any number of such modules, depending upon the capacity required in any particular instance, to be combined together in sequential fluid communication and provides the ability to employ the same or different separation chemistries. Any suitable separation chemistry may be utilized in accordance with the invention. Typical suitable separation chemistries which may be utilized in the processes and apparatus of the invention include reverse phase, ion exchange, hydrophobic interaction, affinity, etc,

In another preferred embodiment, one or more of the individual modules of the separation apparatus includes a detection system for determining the location of the product and unwanted components within the modular units

The processes and apparatus of the invention replace two batch processes, and the separate apparatus required to carry out these batch processes, associated with the current downstream processing of biologically prepared pharmaceutical products, i.e., centrifugation and ultrafiltration, with a single continuous process and one separation column. Further, the lysing of microbial cells may be performed just prior to injection of the mixture onto the modular separation column thus incorporating three batch processes, i.e., cell lysing, centrifugation and ultrafiltration, into one continuous process. Various methods may be utilized for cell disruption and lysis. One such method involves the addition of a surfactant to a fermentation broth while other methods rely on physical techniques such as high shear mixers, sonification and high impact fluidized mixers. Carrying out cell lysis prior to injection of a fermentation broth onto the separation apparatus can eliminate some of the product stability problems typically associated with batch cell lysis thus improving yields and purity of the final product.

### BRIEF DESCRIPTION OF THE DRAWINGS

For a better understanding of the invention as well as other objects and advantages and further features thereof, reference is made to the following detailed description of various preferred embodiments thereof taken in conjunction with the accompanying drawings wherein:

FIG. 1 is a partially schematic side sectional view of one embodiment of an individual separation module utilized in accordance with the invention; and

FIG. 2 is a partially schematic side sectional view of one embodiment of a modular chromatographic separation column according to the invention.

### DESCRIPTION OF THE PREFERRED EMBODIMENTS

As described above, the modular separation column of the invention includes a plurality of individual separation modules in sequential fluid communication with each other. Each separation module contains chemically active capture material which may be collection plates or particulate material.

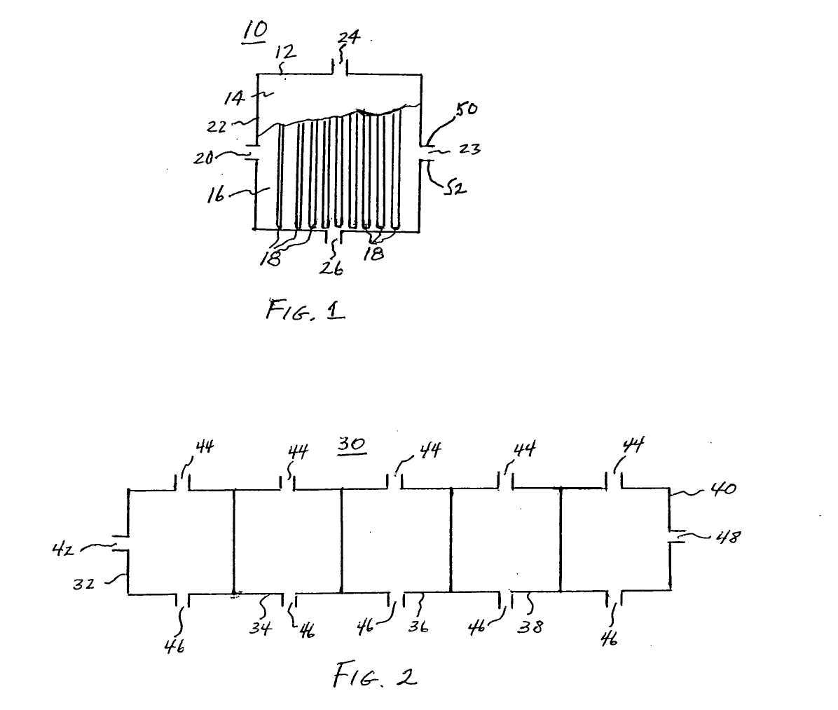

Referring now to FIG. 1 there is seen an individual separation module 10 which is utilized in accordance with the invention. The separation module 10 has a housing 12 which may be of any suitable material such as, for example, polymeric material, metal, etc. The housing 12 is shown with a part of one of the sides 14 cut away to show the chamber 16. The housing 12 includes capture material, in this illustrative instance, a plurality of porous collection plates 18. The porous collection plates are preferably rigid and may be of any suitable materials including metals, such as, for example, sintered stainless steel, metal oxides such as, for example, silicon oxide and aluminum oxide, inorganic materials, organic materials, ceramic materials, hybrids and the like. The porous collection plates 18 have a specific capture chemistry which may be provided by treating the surface of the capture material with a specific chemical such as a suitable polymer coating or by chemical derivatization of the capture material. Any suitable separation chemistry may be utilized in accordance with the invention such as, for example, reverse phase, ion exchange, hydrophobic interaction, affinity, etc. Preferably, affinity chemistry is desirable since there is provided a chemical specificity for the desired product. Where an affinity support is utilized, the entire separation apparatus is utilized for the capture of the desired product and unwanted materials such as cell debris are allowed to flow through the column to be collected as waste or recycled where appropriate. Ion exchange chromatography is a particularly preferred capture and purification chemistry for biological molecules and distribution of products into different separation modules according to the invention.

Some collection plate materials may be chromatographically active without any functional treatment. There are many commercially available chemically active sheet membranes which are suitable for use according to the invention.

The collection plates utilized according to the invention generally have a suitable porosity to allow the fluid mixture to pass through. The flow channels in the porous collection plates are about 50μ or greater, preferably about 75μ or greater and particularly preferably about 100μ or greater. Many such collection plates are commercially available. An example of such a collection plate is an approximately 0.93 inch thick sheet of sintered stainless steel having flow channels of about 50μ which is available from Mott Corporation, Farmington, Conn.

In a preferred embodiment of the invention, by utilizing chemically modified collection plates having the appropriate porosity, i.e., plates having flow channels of about 50μ or greater, direct injection of a lysed fermentation broth into the column will permit the flow through of cell debris to waste, with the option for subsequent capture and reuse, and the simultaneous capture of the desired product by specific interaction with the membrane surface chemistry.

The module 10 may include any number of collection plates 18. Generally, the size of the collection plates, the number of collection plates in any module and the number of individual separation modules in the separation apparatus are determined by the volume of fluid to be injected into the column, e.g., the volume of the fermentation batch, the capture efficiency of the capture material and the fluid dynamics of the system. The capture of a desired product may occur in more than one individual module. Thus, the desired product may be distributed into adjacent modules and the product harvested from these modules.

As mentioned above, particulate capture material may be utilized in accordance with the invention. Typical suitable particulate materials for this purpose are well known in the art and include silica, alumina, and chemically modified particulate supports such as reverse phase, ion exchange, hydrophobic interaction affinity, etc. Suitable particulate materials are available from many commercial sources which are known to those skilled in the art.

Each individual separation module includes a means for allowing fluid to enter the module such as a fluid inlet opening 20 in sidewall 22 of module 10, and means to allow fluid to flow out of the module such as a fluid outlet opening 23. As mentioned previously, each individual separation module may be isolated from the other(s) and the contents from any specific module harvested without the need to collect fractions from the total injected volume. Thus, in a preferred embodiment, module 10, as illustrated, includes a fluid inlet 24 to allow, when the module 10 is isolated, an elutent to be introduced into the chamber 16 of the module to harvest the desired product captured by the collection plates 18 and a fluid outlet 26 to allow the elutent carrying the desired product to be removed from the chamber of the module. As discussed previously, the ability to isolate specific products from specific separation modules minimizes the need to use large amounts of elution solvents. Thus, the separation processes of the invention are cost efficient and environmentally desirable.

In a preferred embodiment of the invention, the separation module includes a distributor plate (not shown) to distribute the fluid entering the module throughout the chamber of the module. The distributor plate typically has approximately the same dimensions as the collection plates 18. The distributor plate typically is a solid plate with openings provided therein to cause the fluid to be distributed substantially uniformly throughout the chamber,

Isolation of an individual module for the purpose of harvesting the product captured in the module can be accomplished by a variety of techniques. In one embodiment, an isolation barrier element, which may be a solid plate, can be arranged to be introduced into the chamber of the module to prevent any additional mixture from entering the chamber while the desired captured product is harvested as described above. In another embodiment, a valve may be arranged between two successive individual modules and serve as the isolation element between modules to isolate the contents of each module. Any off /on or diverter mechanism may be used to isolate one module from another.

Referring now to FIG. 2, there is seen a separation column 30 according to the invention. Separation column 30 is shown with five individual separation modules although, as mentioned above, the separation column of the invention may include two or more of such individual separation modules. The use of a plurality of individual separation modules permits any number of such modules, depending upon the capacity required in any particular instance, to be combined together in sequential fluid communication and provides the ability to attach a column, employing different separation chemistry, to the fluid outlet of a specific module containing the desired product to provide a continuous mixed mode purification method.

For example, the multi-module separation apparatus of the invention may employ ion-exchange capture chemistry and the specific module or modules which contain the desired product may then be connected, utilizing an appropriately positioned fluid outlet, to a reverse phase column whereby, using mobile phase conditions which are known to those skilled in the art, the desired product which is present on the capture materials is eluted onto the reverse phase column where the product is partitioned onto the reverse phase and desalting has been accomplished. By using the appropriate mobile phase conditions the desired product may be then eluted and collected.

The separation column 30 is shown in this embodiment with five individual separation modules, 32, 34, 36, 38 and 40 in sequential fluid communication. Although the separation column 30 is shown with the individual separation modules in a horizontal orientation, the individual modules may be arranged vertically in which case the fluid flow may be from top to bottom or from the bottom to the top.

Module 32 includes a first fluid inlet 42 to allow a fluid containing a mixture of biological components to be introduced into the column, and a second fluid inlet 44 and a second fluid outlet 46 which are utilized when module 32 is isolated for the purpose of harvesting the product captured in module 32. Of course, modules 34-40 include fluid inlet means (not shown)to allow the fluid to enter the module. Modules 34-40 are also shown with optional fluid inlets 44 and fluid outlets 46 to allow the material captured in each of the modules to be harvested directly from the module without having to be passed through any of the other separation modules. Module 40 is also shown with a fluid outlet 48 to allow the remainder of the fluid mixture, after individual materials have been removed by the capture materials of the other modules, to be removed from the column.

As mentioned previously, each individual separation module may be isolated from the other(s) and the contents from any specific module harvested without the need to collect fractions from the total injected volume. As previously discussed, a valve can be provided between each separation module as the isolation element to allow the individual separation modules to be isolated from the others when desired. Various other isolation elements such as solid plates may be used.

In one embodiment of the invention, similar but different capture chemistries may be employed in respective individual separation modules of the multi-module separation apparatus of the invention. For example, the first module in the separation column into which the volume of fluid containing the mixture of components is injected, module 32 in FIG. 2, may include capture material having specific capture chemistry directed to the removal of interfering undesired materials such as nucleic acids in lysates. The desired product or products in the fluid can then be bound in one or more of the subsequent individual separation modules in the separation column employing similar but different capture chemistry.

Similarly, where different capture chemistries are utilized in each of the individual separation modules in the separation column, by manipulation of the sample injection mobile phase, whereby the ratio of the injection mobile phase to the elution mobile phase is adjusted, it is possible to isolate different materials in each module based on the interaction between the stationary phase, i.e., the capture material, and the products in the mixture, e.g., based on hydrophobic or electronic interactions, etc. For example, where the fluid contains molecules which vary in hydrophobic character, e.g., in decreasing order of hydrophobicity, and the separation column contains individual modules which have respective capture materials of increasing order of hydrophobicity such that the capture material in the preceding module is less strongly hydrophobic than that of the next succeeding module, the products in the fluid mixture can bind to the stationary phase based on their hydrophobic character. For the purpose of illustration, consider a fluid mixture which contains three products of interest and the fluid mixture is injected into a modular separation column according to the invention which includes three individual separation modules. In this illustrative instance, the most strongly hydrophobic product will bind to the least hydrophobic capture material in the first separation module, the lesser strongly hydrophobic product will bind to the more hydrophobic capture material in the second module and the least hydrophobic of the products will bind to the most hydrophobic capture material in the third module. Thus, according to the invention, each of the individual products can be harvested from the individual module where it is captured by utilizing techniques which are known in the art.

In another embodiment of the invention, different capture chemistries may be utilized in the individual modules of the separation column. Under appropriate conditions where the components in a particular fluid injection sample vary in their binding coefficients with the stationary phase, based on, for example, hydrophobic, ionically charged and hydrophobic/ionically charged interactions, the modular nature of the separation apparatus of the invention makes it possible to utilize a stationary reverse phase capture in one or more modules and an ion exchange stationary phase in one or more modules to capture different components from the mixture in the first pass of the fluid through the column. In this instance the injection mobile phase will be compatible for binding to either stationary capture phase. As described above, harvesting of the captured product from each individual module can be accomplished by techniques known to those skilled in the art.

As stated previously, in a preferred embodiment of the invention one or more of the individual modules includes a detection system for determining the location of the product and unwanted components within a module. One suitable detection system measures light in ultraviolet regions. The detection system can be a fiber optic system which includes a fiber to carry the light from the light source, typically located outside the module, to a specific location in the separation module and another fiber to collect the light after it has been passed through the fluid mixture and carry it to a detector element which typically also is located outside the module. For example, (see FIG. 1) an optical fiber (not shown) can be provided to carry light from a light source (not shown) located outside the module to the vicinity of a first transparent window (not shown) in the top surface 50 of outlet tube 23 (which also serves a the inlet tube for the next separation module) and a second optical fiber (not shown), located in the vicinity of a second transparent window (not shown) in the bottom surface 52 of tube 23, provided to collect the light after it has passed through the fluid mixture and carry it to a detector (not shown) outside the module where the absorbance is monitored to determine the components of the fluid mixture entering the module.

Another detector system would employ a splitter valve between modules to divert a portion of effluent directly to a UV detector located within the module to measure the light absorbed by the fluid mixture.

The detector system preferably has a tunable wavelength capability so as to be able to detect various materials which absorb at different wavelengths. For example, proteins and many organic molecules absorb in the ultraviolet at 254 nm, nucleic acids absorb at 260 and/or 280 nm and various organic molecules at 224 to 228 nm.

The fluid mixture to be separated may be injected into the separation column under pressure due to the pumping of the mobile phase, i.e., the flow rate of the fluid, and possible back pressure, if any. High or low pressure may be used.

The individual separation modules may be held at any temperature and may be heated or cooled as required. For example, one separation module may be heated, another cooled and another held at room temperature, dependent primarily upon the particular capture interaction taking place in the module.

The separation column of the invention, with the ability to allow collection of a particular product from one module, can provide large electrophoretic preparative separations by manipulation of isoelectric focusing chemistry in different modules. Isoelectric focusing involves the principle of focusing a protein within a pH gradient where the pH matches its isoelectric point (pl). In this embodiment, the separation of amphoteric materials on the basis of a difference in their isoelectric points may be accomplished by assembling a separation column wherein the capture chemistry chosen in each individual module in the column is designed to provide a defined pH gradient between each module of the column. This can be accomplished by immobilizing amphoteric polymers representing different pH levels onto the collection material in each module with the amphoteric polymeric material in each module having a specific pH.

### EXAMPLES

The invention will now be described further in detail with respect to specific preferred embodiments by way of examples, it being understood that these are intended to be illustrative only and not limiting of the scope of the invention. Various changes and modifications to the disclosed embodiments will be apparent to those skilled in the art. Such changes and modifications, including without limitation, those relating to the materials, process parameters, and/or methods of the invention may be made without departing from the spirit of the invention and the scope of the appended claims. All parts and percentages recited are by weight unless otherwise specified.

### Example I

This example describes the normal phase separation of two dyes from a solution using a three segment, prototype glass modular column according to the invention.

The column included a first unit, or segment, with a volume of 15 ml, which acted as the sample loading unit and separation modules #1 and #2, with volumes of 35 ml. Separation was completed, with the modular column in a vertical configuration, using slight vacuum applied to the collection receivers. .

Indophenol Blue (0.5 gram) and of Sudan Red (0.5 gram) were dissolved in methylene chloride (50 cc) to which was added silica particles (4 grams) (40-60μ, 500 meters²/gm , 60 Å pore, available from Silicycle) and the solvent removed under vacuo using a Roto-Vap.

Separation modules #1 and #2 were each packed with 17 gms of the silica, using slurry packing techniques with toluene. The three modules were assembled into a single column, each of the modules having the capability of being isolated from one another by use of a stopcock between modules so any material captured in a module could be specifically desorbed from that particular module.

A solvent delivery reservoir was attached to the top of the modular column. Module 1 was empty to serve as the sample loading module and was attached to silica packed module 2 which in turn was attached to silica packed module 3. The column was equilibrated with several column volumes of 100% toluene.

A thin bed of silica particles, about 15 mm thick, was placed in module#1, covered with sand, to which was applied 0.25 gms of the dye coated silica and then covered with hexane. The solvent reservoir containing 100% toluene was attached to the top of the modular column and solvent flow was started by opening the stopcock valve of the reservoir and application of a slight vacuum on the receiving flask. The dyes separated with Indophenol Blue being captured in separation module#1 and Sudan Red in separation module#2.

By practicing conventional normal phase chromatography, which included eluting the contents of separation module #1 through the total volume of the modular separation column, i.e., through separation modules #1 and #2, Indophenol Blue was eluted off the column using 580 cc of solvent.

By employing the modular separation process according to the invention Indophenol Blue was isolated in separation module #1 and eluted directly from module #1 with three column volumes of solvent without having to be passed through separation module #2. The total amount of solvent used employing the modular process according to the invention was 325 cc. This represented a 44% decrease in the amount of solvent using a modular column apparatus and process according to the invention as compared to conventional normal phase column separation techniques.

Sample identification and analysis was carried out by Thin Layer Chromatography (TLC).

### Example II

This example describes the direct capture of reagents of differing hydrophobicities using a three segment, prototype glass modular column. The individual modules contained similar but different capture materials. Solvent flow was effected by slight vacuum on the collection receivers.

The capture materials used were C-4 silica (37-55 μm), available from Silicyle and C-18 silica (40-63 μm) available from Waters Corp. The reagents used were dimethyl phthalate and dioctyl phthalate, available from Aldrich.

A solvent delivery reservoir was attached to the top of a modular column assembled from three individual segments of which a first unit, or segment, was used for sample loading and two separation modules were used for product separation. Separation module #1 was slurry packed with 15 grams of C-4 capture material and separation module #2 slurry packed with 15 grams of C-18 capture material. Both separation modules were slurry packed using 100% acetonitrile. The assembled modular column was equilibrated with 50/50 (v/v) acetonitrile/water and then with 100% water.

Dimethyl- and dioctyl phthalate (0.25 gm each) were dissolved in about 1cc acetonitrile and injected into the sample loading unit of the column. Immediately after injection, the flow of solvent was started and the column was subjected to two column volumes of 40/60 (v/v) of an acetonitrile/water mixture. The separation modules were isolated from each other and the reagents were eluted directly from each module with 100% acetonitrile.

Analysis by TLC showed that dioctyl phthalate was eluted from separation module #1 which contained the C-4 capture material and dimethyl phthalate from separation module #2 which contained the C-18 capture material.

Although the invention has been described in detail with respect to various preferred embodiments, it will be understood that these are intended to be illustrative only and the invention is not limited thereto, but rather that those skilled in the art will recognize that variations and modifications may be made therein which are within the spirit of the invention and the scope of the appended claims.

What is claimed is:

1. A chromatographic separation apparatus for separating components from a mixture of components in a fluid comprising
a plurality of individual separation modules in sequential fluid communication, each said separation module including a chemically active capture material,
at least one of said separation modules including means selectively operable to isolate said at least one separation module from any other separation module; and
said at least one said separation module including fluid inlet and fluid outlet means operable when said at least one separation module is isolated from any said other separation modules for allowing at least a portion of a component captured by said capture material of said at least one separation module to be removed from said at least one separation module without passing through any other separation module.

2. The chromatographic separation apparatus as defined in claim 1 wherein the chemically active capture material of each said separation module has the same chemical activity.

3. The chromatographic separation apparatus as defined in claim 1 wherein at least one of said separation modules includes a first chemically active capture material and at least one of said separation modules includes a second chemically active capture material, said first and second chemically active capture materials having different chemical activities.

4. The chromatographic separation apparatus as defined in claim 1 wherein said capture material of at least one of said separation modules comprises a porous collection member having flow channels of about 50μ or greater.

5. The chromatographic separation apparatus as defined in claim 4 wherein said separation module includes a plurality of said collection members.

6. The chromatographic separation apparatus as defined in claim 1 wherein said capture material of at least one of said separation modules comprises particulate material.

7. The chromatographic separation apparatus as defined in claim 6 wherein the particle size of said particulate material is about 100μ.

8. The chromatographic separation apparatus as defined in claim 1 wherein at least one of said plurality of individual separation modules further includes a detection system for determining the location of a component in said module.

9. The chromatographic separation apparatus as defined in claim 1 and further including a sample loading module.

10. The chromatographic separation apparatus as defined in claim 1 wherein each of said separation modules has a fluid inlet and fluid outlet means for allowing a component captured by said capture material of each said separation module to be removed from said separation module without passing through any other said separation module.

11. A chromatographic separation process comprising passing a fluid containing a mixture of different components through a chromatographic separation apparatus as defined in claim 1, whereby at least a portion of a component of said mixture is captured by the capture material of at least one separation module.

12. The chromatographic separation process as defined in claim 11 wherein said fluid comprises a fermentation broth which includes components which are the products of recombinant DNA processes.

13. The chromatographic separation process as defined in claim 11 wherein the chemically active capture material of each said separation module has the same chemical activity, whereby the capture material of each said separation module captures a portion of the same component of said mixture.

14. The chromatographic separation process as defined in claim 11 wherein at least one of said separation modules has a first chemically active capture material and at least one of said separation modules has a second chemically active capture material, said first and second capture materials having different chemical activity, whereby said first capture material captures at least a portion of a first component in said mixture and said second capture material captures at least a portion of a second component of said mixture.

15. The chromatographic separation process as defined in claim 11 wherein said capture material of at least one of said separation modules comprises a porous collection member having flow channels of about 50μ or greater.

16. The chromatographic separation process as defined in claim 15 wherein said separation module includes a plurality of said collection members.

17. The chromatographic separation process as defined in claim 11 wherein said capture material of at least one of said separation modules comprises particulate material.

18. The chromatographic separation process as defined in claim 17 wherein the particle size of said particulate material is about 100μ.

19. The chromatographic separation process as defined in claim 11 wherein at least one of said plurality of individual separation modules further includes a detection system for determining the location of a component in said module.

20. The chromatographic separation process as defined in claim 11 and further including removing the component captured by the capture material of at least one said separation module directly from said separation module without passing said component through any other said separation module.
